(19) United States
(12) Patent Application Publication
(10) Pub. No.: US 2007/0212663 A1
(43) Pub. Date: Sep. 13, 2007

(54) Dental model

(76) Inventor: Gerd Oestreich, San Diego (SV)

Correspondence Address: Mark P. Stone, 4th Floor, 25 Third Street, Stamford, CT, 06905, US

(21) Appl. No.: 11/715,281

(22) Filed: Mar. 7, 2007

(30) Foreign Application Priority Data
Mar. 9, 2006 (DE) 10 2006 012 123.6

(51) Int. Cl. A61C 11/00

(52) U.S. Cl. 433/213

(57) ABSTRACT

The invention relates to a dental model with a base body (1), which has an essentially U-shaped dental arch (2) on its upper side. The side ridges of the dental arch and/or its front ridge are or is provided with at least one dental work (4, 5) for demonstration purposes. In order to facilitate a larger number of dental works than allowed in the dental models known until now without significantly changing the outer appearance of the model, the invention provides for the base body (1) also to have an essentially U-shaped dental arch (3) on its underside, whereby the side ridges and/or front ridge of this dental arch (3) are or is likewise provided with at least one dental work (6) for demonstration purposes. Furthermore, a base (7) with a recess (8) for holding that dental arch which is not being demonstrated is assigned to the base body (1).

### BACKGROUND OF THE INVENTION

The invention relates to a dental model with a base body, which, on its upper side, has an essentially U-shaped dental arch whose side ridges and/or front ridge are or is provided with at least one dental work for demonstration purposes.

Dental models of the preceding type are known in various embodiments, e.g., from WO 84/03978, EP 0 253 757 B1 and U.S. 3 478 428. In all of the known models, it is possible to mount dental works on one of the dental arches, one at a time. It is understood that, particularly in the case of discussions between the doctor and patient, there is considerable interest in providing the patient with comprehensive advice while demonstrating as many alternatives as possible to the patient. The same holds true for teaching and continuing education events. Because in practice, a dental arch offers room for only a limited number of dental works, EP 0 253 757 B1 already suggests that a portion of the dental arch with a turning insert piece, which is provided with various dental works. In the last-mentioned case, however, a certain impairment of the appearance of the gum or floor of the mouth of the model surrounded by the dental arch must be accepted.

### SUMMARY OF THE INVENTION

The object of the invention is to create a dental model that allows the presentation of a larger number of dental works than do dental models known as of this time, without the outer appearance of the model showing significant deviations from known models with regard to its shape and size. The above object is solved in accordance with the invention in that the base body, for demonstration purposes, also has on its underside an essentially U-shaped dental arch, whose side ridges and/or front ridge are or is also provided with at least one dental work, and in that a base with a recess is allocated to the base body, for the purpose of holding that dental arch that is not being demonstrated.

The dental model according to the invention offers the advantage that considerably more dental works can be presented with its help than with the models known hitherto. At the same time, it proves to be especially advantageous if the upper edge of the recess of the base lies flush against the circumference of the base body in both possible positions of the base body. In this case, impairments of the appearance of the roof of the mouth, the floor of the mouth and the side cheek area of the mouth are avoided, whereby these impairments, such as those necessitated by the design of the solution disclosed in EP 0 253 757 B1, are caused by disturbing open sections or gaps. Naturally, with the new model, it is also possible to connect all dental works to the dental arch in such a way that they are interchangeable.

In order to ensure a proper fit of the dental arch in the base, it is recommended that the recess of the base be given an essentially U-shaped supporting tab adapted to the edge profiles of the dental arch, for the base body.

The easy handling of the dental model is accommodated if a spring element is arranged on the bottom of the recess, whereby this spring element presses against the central area that is facing it of the roof or bottom of the mouth of the base body, and if the base body is provided with locking units acted on by the springs, whereby to these locking units are allocated ends of bore holes in the base, from which holes the locking units can be removed by pressure pins that can be operated from the exterior of the base, and whereby these pressure pins are fed into the base in such a way that they can be slid back and forth to a limited extent in the side cheeks of the base.

### BRIEF DESCRIPTION OF THE DRAWINGS

Further features and details of the invention follow from the attached drawings and from their subsequent description. Shown are:

FIG. 1 the perspective view of the base body and the socket of a dental model accommodating the latter,

FIG. 2 a detail of the dental model according to FIG. 1 in the locked state of its base body,

FIG. 3 the detail of the dental model according to FIG. 2 in the release position for the base body,

FIG. 4 the perspective view of the base of the dental model after the removal of the socket body,

FIG. 5 the perspective view of the base body with its two dental arches that can be equipped with dental works and

FIG. 6 a base body provided with a number of dental works.

### BEST MODES FOR CARRYING OUT THE INVENTION

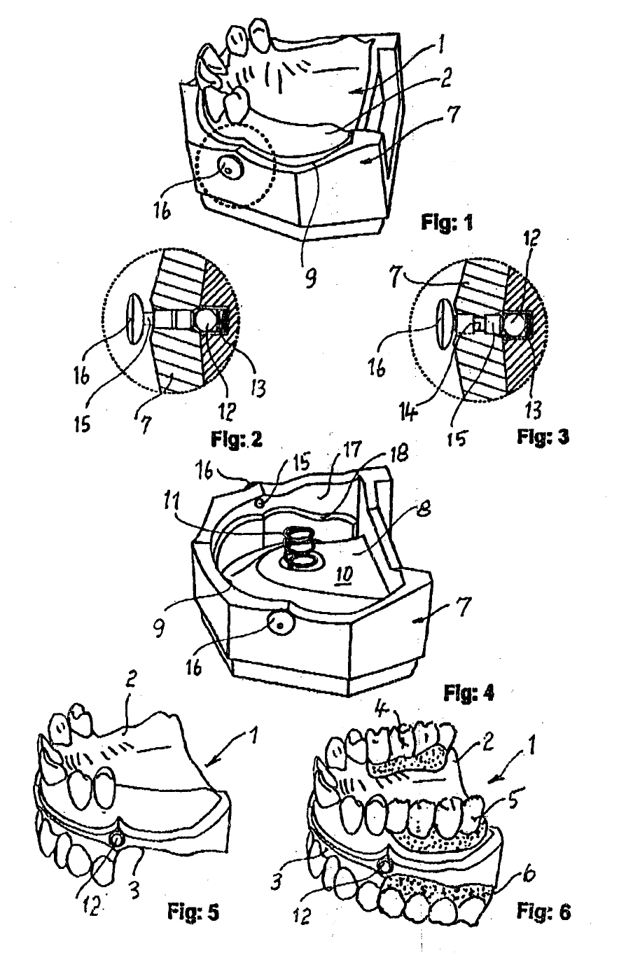

In the figures, 1 is the base body of a dental model, which has two essentially U-shaped dental arches 2 or 3, one on its upper side and one on its lower side. Both dental arches 2 and 3 can, as shown in FIG. 6, be equipped in the area of their side ridges with dental works 4, 5 and 6. It is therefore possible, for example, to demonstrate both the conditions on an upper jaw and those on a lower jaw, one after the other, using just a single model. A base 7 is allocated to the base body 1, whereby this base 7 has a depression or recess 8, which serves to hold one of each of the dental arches 2 or 3 of the base body 1 respectively. As can be seen in FIG. 1, the upper edge 9 of the recess 8 of the base 7 lies flat against the facing edge of the base body 1 facing it.

In the area of the bottom 10 of the recess 8 of the base 7, a spring element 11 is arranged, which lies against the facing area of the roof or the floor of the mouth of the base body 1, and which attempts to press this area out of the recess 8. In order to prevent an unwanted movement of the base body 1 out of the recess 8, the base body 1 is given locking elements on its opposing sides, each of which, in the case shown, is formed by a ball 12, and each of which is pressed into the end of bore holes 14 by a spring 13. Pressure pins 15, which can be moved back and forth to a limited extent, are fed into the bore holes 14, whereby the balls 12 can be removed from their position which holds the base body 1 in the recess 8 with the help of the pressure pins. When pressure is exerted on the ends 16 of the pressure pins 15 with the help of the thumb and index finger of the user of the dental model, the base body 1 immediately springs out of a recess 8.

In order to guarantee a proper fit of the base body 1 in the socket 7, the inner wall 17 of the recess 8 is given an essentially U-shaped supporting tab 18 around the circumference, whereby the profile of this supporting tab 18 is matched to the profile of a U-shaped edge 19 around the circumference of the base body 1.

Naturally, the described model can be used to present not only pathologically related dental works, so that it is also easily possible to portray medical conditions or cosmetic design possibilities using the model. Because of its compactness and versatility, it is notably suitable for use in lectures and speaking events.

1. Dental model with a base body (1) which, for demonstration purposes, has on its upper side an essentially U-shaped dental arch (2), whose side ridges and/or front ridge are or is also provided with at least one dental work (4, 5), characterised in that the base body (1) also has, on its underside, an essentially U-shaped dental arch (3), whose side ridges and/or front ridge are or is, for demonstration purposes, likewise provided with at least one dental work (6), and in that a socket (7) with a recess (8) for holding that dental arch that is not being demonstrated is allocated to the base body (1).

2. Dental model according to claim 1, characterised in that the upper edge (9) of the recess (8) of the base (7) lies flush against the circumference of the base body (1) in both possible positions of the base body (1).

3. Dental model according to claim 1, characterised in that the recess (8) of the base (7) is provided with an essentailly U-shaped supporting tab (18), adapted to the edge profiles of the dental arches, for the base body (1).

4. Dental model according to claim 1, characterised in that on the bottom of the recess (8), a spring element (11) is arranged, which presses against the central area of the roof of the mouth or bottom of the mouth of the base body (1) facing it.

5. Dental model according to claim 4, characterised in that the base body (1) is provided with locking units (12) acted on by spring (13), whereby these locking units (12) are associated to ends of bore holes (14) in the base (7), from which the locking units (12) can be removed by pressure pins (15) that can be operated from the exterior of the socket (7).

6. Dental model according to claim 5, characterised in that the pressure pins (15) can be moved back and forth to a limited extent in side cheeks of the socket (7).

7. Dental model according to claim 2, characterised in that the recess (8) of the base (7) is provided with an essentailly U-shaped supporting tab (18), adapted to the edge profiles of the dental arches, for the base body (1).

8. Dental model according to claim 2, characterised in that on the bottom of the recess (8), a spring element (11) is arranged, which presses against the central area of the roof of the mouth or bottom of the mouth of the base body (1) facing it.

9. Dental model according to claim 3, characterised in that on the bottom of the recess (8), a spring element (11) is arranged, which presses against the central area of the roof of the mouth or bottom of the mouth of the base body (1) facing it.

10. Dental model according to claim 7, characterised in that on the bottom of the recess (8), a spring element (11) is arranged, which presses against the central area of the roof of the mouth or bottom of the mouth of the base body (1) facing it.

11. Dental model according to claim 8, characterised in that the base body (1) is provided with locking units (12) acted on by spring (13), whereby these locking units (12) are associated to ends of bore holes (14) in the base (7), from which the locking units (12) can be removed by pressure pins (15) that can be operated from the exterior of the socket (7).

12. Dental model according to claim 9, characterised in that the base body (1) is provided with locking units (12) acted on by spring (13), whereby these locking units (12) are associated to ends of bore holes (14) in the base (7), from which the locking units (12) can be removed by pressure pins (15) that can be operated from the exterior of the socket (7).

13. Dental model according to claim 11, characterised in that the pressure pins (15) can be moved back and forth to a limited extent in side cheeks of the socket (7).

14. Dental model according to claim 12, characterised in that the pressure pins (15) can be moved back and forth to a limited extent in side cheeks of the socket (7).
